(19) United States
(12) Patent Application Publication
(10) Pub. No.: US 2014/0207603 A1
(43) Pub. Date: Jul. 24, 2014

(54) System for Personalizing a Notification Message

(71) Applicants: Yaron Orenstein, Tel-Aviv (IL); Nir Ofir, Shoham (IL)

(72) Inventors: Yaron Orenstein, Tel-Aviv (IL); Nir Ofir, Shoham (IL)

(21) Appl. No.: 14/237,689

(22) PCT Filed: Aug. 9, 2012
(86) PCT No.: PCT/IL2012/000297

§ 371 Date: Feb. 28, 2014

Related U.S. Application Data
(60) Provisional application No. 61/521,460, filed on Aug. 9, 2011.

(51) Int. Cl. G06Q 30/06; H04L 12/58

(52) U.S. Cl. CPC G06Q 30/0603; H04L 51/24
USPC 705/26.1

(57) ABSTRACT

The present invention discloses a computerized system for personalizing a notification message, comprising: (a) a communication device for display a digital content on notification (b) a computer readable medium comprising one or more functional modules including (i) a receiving unit for enabling a user to personalized his incoming notification; (ii) a sending unit for enabling a user to personalized his outgoing notification, (iii) an uploading unit for enabling a user and/or publisher to upload a digital content; (iv) a downloading unit for enabling a user to downloaded a digital content. The communication device configured to utilized said units for personalized an outgoing and incoming notification, for presenting said personalized notification on said contact communication device, and for enabling transactions regarding ordering and purchasing said digital content.

### FIELD OF THE INVENTION

The present invention generally relates to communication and in particular to personalizing a notification.

### BACKGROUND OF THE INVENTION

A notification message is a message notifying a recipient about a new event. The notification message typically includes the identification of the origin and a text message. Each application has it's own notification messages. Examples of notification messages are SMS, MMS, Email message, Facebook notification message, twitter notification message, voice over IP (VOIP) notification message and the like.

There are methods known in the art that provides the sender of a message an option to personalize the notification message.

US2009270115A to Brun, Arnaud et al discloses method and a system for personalized notification of reception of a message, comprising a step of composing an MMS message on a first terminal and a step of sending the MMS message to a second terminal. Before the step of sending the MMS message, the first terminal inserts a page containing a notification element in said MMS message. Upon reception of the message by the second terminal, reception thereof is notified by means of the notification element inserted in the message.

US2007190983 to David Eliot et al discloses a method that provides media content chosen by a first user to be played by a media player on a device of a second user in response to an identification of said first user.

There is a long felt need for a complete personalization of the communication system.

### SUMMARY OF THE INVENTION

It is therefore an object of the present invention to provide a computerized system for personalizing a notification comprising: (a) a communication device for display a digital content on notification [120] (b) a computer readable medium comprising one or more functional modules including (i) a receiving unit for enabling a user to personalized his incoming notification; (ii) a sending unit for enabling a user to personalized his outgoing notification. (iii) an uploading unit for enabling a user and/or publisher to upload a digital content; (iv) a downloading unit for enabling a user to downloaded a digital content; wherein said communication device configured to utilized said units for personalized an outgoing and incoming notification, for presenting said personalized notification on said contact communication device, and for enabling transactions regarding ordering and purchasing said digital content.

It is further object of the present invention to disclose a system as define above, wherein said computerized system configured to be an app and/or a web site running on a communication device.

It is a further object of the present invention to disclose a system as define above, wherein said receiving unit comprising: a notification service module [410], a notification listener module [420] and, a cross-notification service routing module [430], a digital content source [510] and a digital content storage [310].

It is a further object of the present invention to disclose a system as define above, wherein said sending unit comprising: a notification service module [410], and a digital content storage [310], a notification listener module [420] and, a cross-notification service routing module [430], and a digital content source [510].

It is a further object of the present invention to disclose a system as define above, wherein said uploading unit comprising: a digital content market [110], a database [140], a digital content storage [310], a server [130].

It is a further object of the present invention to disclose a system as define above, wherein said downloading unit comprising: digital content market [110], server [130], database [140] and a digital content storage [1].

It is a further object of the present invention to disclose a system as define above, wherein said communication device selected from a group consisting of: electronic, digital, and computerized device adapted for receiving and presenting and/or creating a notification.

It is a further object of the present invention to disclose a system as define above, wherein said notification comprises information which configured to pass to a user

It is a further object of the present invention to disclose a system as define above, wherein said notification selected from a group consisting of an alert on new or changed information, an event, a reminder or subscription that is due.

It is a further object of the present invention to disclose a system as define above, wherein said information configured to be passed to a user via said notification service [410].

It is a further object of the present invention to disclose a system as define above, wherein said notification service selected from a group consisting of: sms, email, Instant Messaging services, Social services, twitter or facebook message, calender events, user or service or company status changes, Cloud based services, operating systems, third party applications—calender, wakeup call and any other suitable notification service known in the art.

It is a further object of the present invention to disclose a system as define above, wherein said notification further comprises detailed information of said event.

It is a further object of the present invention to disclose a system as define above, wherein said digital content comprises a digital media and/or content configured to be presented and/or played onto a user said communication device [120].

It is a further object of the present invention to disclose a system as define above, wherein said digital media are selected from a group consisting of video, audio, images, text, music, web content, animation, whole or part of movies, TV content or any other suitable means known in the art.

It is a further object of the present invention to disclose a system as define above, wherein said digital content further comprises at least one advertisement.

It is a further object of the present invention to disclose a system as define above, wherein said digital content is further configured to be promoted in the digital content catalog by a publisher and/or an advertiser.

It is a further object of the present invention to disclose a system as define above, wherein said digital content further comprises additional content added on top of and/or as part of said digital content.

It is a further object of the present invention to disclose a system as define above, wherein said additional content selected from a group consisting of advertisements, external links, videos, text, and localized content.

It is a further object of the present invention to disclose a system as define above, wherein said localized content is configured to be events and/or weather information.

It is a further object of the present invention to disclose a system as define above, wherein said digital content further configured to be track-able and measured for payment of an advertiser.

It is a further object of the present invention to disclose a system as define above, wherein said measured is executed by measures selected from a group consisting of: cost per click, cost per view, cpm, cpv and any other suitable tracking ad measures known in the art.

It is a further object of the present invention to disclose a system as define above, wherein said digital content configured to be created or edited by a publisher or by a user itself.

It is a further object of the present invention to disclose a system as define above, wherein said digital content comprises personal features.

It is a further object of the present invention to disclose a system as define above, wherein said personal features selected from a group consisting of signature, an avatar, a personal representation of a person, and an organization representation.

It is a further object of the present invention to disclose a system as define above, wherein said digital content configured to be presented via digital content catalog in several different ways.

It is a further object of the present invention to disclose a system as define above, wherein said different ways of presentation comprising category based, search based, popular and any other conventional presentations known in the art.

It is a further object of the present invention to disclose a system as define above, wherein said ways of catalog presentation configured to be defined according to characteristic selected from a group consisting of: localization, partner, publisher, distribution channel, and a user profile and/or characteristics.

It is a further object of the present invention to disclose a system as define above, wherein said downloading unit further comprising a digital content catalog configured to presented available said digital content for user in the system.

It is a further object of the present invention to disclose a system as define above, wherein said digital content storage adapted for storing said digital content.

It is a further object of the present invention to disclose a system as define above, wherein said digital content storage further configured to be internal and/or external digital content storage [510] to the computerized system.

It is a further object of the present invention to disclose a system as define above, wherein said digital content storage selected from a group consisting of: database, a storage device/system, a user personal storage, CDN service, internet digital content service or site or system.

It is a further object of the present invention to disclose a system as define above, wherein said digital content storage further configured to be part of said notification service.

It is a further object of the present invention to disclose a system as define above, wherein said external digital content storage configured to be consumed from publishers systems and/or external services.

It is a further object of the present invention to disclose a system as define above, wherein said database selected from a group consisting of: oracle, MS Sql, My Sql, NoSql, cloud based Database and/or any other conventional means known in the art.

It is a further object of the present invention to disclose a system as define above, wherein said storage device/system are selected from a group consisting of EMC, netapp, cloud based storage and/or any other conventional storage known in the art.

It is a further object of the present invention to disclose a system as define above, wherein said user personal storage selected from a group consisting of computer hard disk, an SD card, and/or any other conventional means known in the art

It is a further object of the present invention to disclose a system as define above, wherein said Internet digital content service, site or system are selected from a group consisting of youtube, Netflix, and any other conventional means known in the art.

It is a further object of the present invention to disclose a system as define above, wherein said external services further configured to be part of said notification service.

It is a further object of the present invention to disclose a system as define above, wherein said part of said notification service comprises an MMS, mail attachments, file uploads, and any other conventional notification that support digital content sending and sharing that known in the art.

It is a further object of the present invention to disclose a system as define above, wherein said database configured to stored data selected from a group consisting of: user and/or service data, system records, and said digital content catalog data.

It is a further object of the present invention to disclose a system as define above, wherein said database selected from a group consisting of oracle, MS Sql, My Sql, NoSql, cloud based Database, EMC, netapp, cloud based storage and any other conventional database known in the art.

It is a further object of the present invention to disclose a system as define above, wherein said uploading unit further comprising a digital content management module comprises an interface configured to enabling a publisher and/or partners to uploaded and managed said digital content and said user's notification personalization service.

It is a further object of the present invention to disclose a system as define above, wherein said digital content management module further configured to be an application and/or a web site.

It is a further object of the present invention to disclose a system as define above, wherein said digital content management module further configured to enabled a publisher to views said digital content data.

It is a further object of the present invention to disclose a system as define above, wherein said digital content data selected from a group consisting of: statistics, transaction and usage.

It is a further object of the present invention to disclose a system as define above, wherein said digital content market module comprises a user interface configured to allowed a user to choose and purchase said digital content for notification personalization.

It is a further object of the present invention to disclose a system as define above, wherein said digital content market module configured to be an application and/or a web site.

It is a further object of the present invention to disclose a system as define above, wherein said communication device adapted for displaying said digital content on a notification according to a user configuration.

It is a further object of the present invention to disclose a system as define above, wherein communication device further configured to hosts a runnable logic which configured to be part of the system.

It is a further object of the present invention to disclose a system as define above, wherein said runnable logic is selected from a group consisting of computer readable medium, application, web pages, scripts or other conventional runnable logic known in the art.

It is a further object of the present invention to disclose a system as define above, wherein said notification listener module adapted for connecting to a notification services and allowing an initiation of a notification personalization presentation on time of said notification.

It is a further object of the present invention to disclose a system as define above, wherein said cross-notification service routing module configured to use an information of users and/or contacts for routing notification to user's communication device.

It is a further object of the present invention to disclose a system as define above, wherein said receiving unit and wherein said sending unit are further comprising a server [130].

It is a further object of the present invention to disclose a system as define above, wherein said notification service further comprises an external notification service.

It is a further object of the present invention to disclose a system as define above, wherein said external notification service selected from a group consisting of: SMSC for smses, or facebook servers for facebook notifications, and email servers.

It is a further object of the present invention to disclose a system as define above, wherein said notification service module further comprises an internal notification service.

It is a further object of the present invention to disclose a system as define above, wherein said computerized system operating in a method of: (a) receiving a notification with said associated digital content; (b) uploading and/or downloading said digital content, and; (c) identifying at least one characteristic of the notification, and; (d) associating a digital content with at least one of said characteristics of said notification; (e) displaying said digital content which associated with at least one characteristic according to notification personalization definitions; and (f) providing means for enabling user to choose which notification service to use by cross notification services communication. (g) sending said notification with said associated digital content to a receiver client. (h) enabling transactions regarding ordering and purchasing said digital content.

It is a further object of the present invention to disclose a system as define above, wherein said at least one characteristic selected from a group consisting of: contact, the content of said message, the message type, a service, notification data, user profile, initiating contact details of the notification, the notification details itself (e.g. text), user profile and details, time, date, holidays and events and any combination thereof

It is a further object of the present invention to disclose a system as define above, wherein said receiving unit configured to provide a user interface and/or experience for receiving and initiating a notifications, regardless of which notification service is used to receive or send said notification.

It is a further object of the present invention to disclose a system as define above, wherein said receiving unit further provided user the ability to relate and view full contact cross-notification service details information, irrelevantly to the notification service which used to received and/or initiate a notification.

It is a further object of the present invention to disclose a system as define above, wherein said cross-notification service routing module configured to enabled a user to choose, and/or reply and/or initiate said notification in said different notification service which was used to initiate said notification.

It is a further object of the present invention to disclose a system as define above, wherein said receiving unit module further configured to wake up said communication device to a fully active state and to presented said digital content even said communication device is in battery saving or resource preserving state.

It is a further object of the present invention to disclose a system as define above, wherein said battery saving or resource preserving state selected from a group consisting of: sleep mode, idle mode, screen turned off, locked or any other conventional state of battery saving or resource preserving.

It is a further object of the present invention to disclose a system as define above, wherein said upload unit adapted for providing publisher with a platform configured to enabled said publisher to upload, and/or share, and/or sell said digital content.

It is a further object of the present invention to disclose a system as define above, wherein said receiving unit further configured to provide users with the ability to personalize their notifications using a digital content created by said publisher.

It is a further object of the present invention to disclose a system as define above, wherein said computerized system further comprising a module adapted for providing partner the ability to use said notification personalization service and to provide it to his customers, with his own definitions and flavor.

It is a further object of the present invention to disclose a system as define above, wherein said partner's definitions and flavor selected from a group consisting of exclusive, brand and co-branded.

It is a further object of the present invention to disclose a system as define above, wherein said upload unit further configured to enabled a user to uploaded content through his communication device [120] or through said central digital content market [110].

It is a further object of the present invention to disclose a system as define above, wherein said sending unit and wherein said receiving unit further configured to send a request said server to get the latest digital content catalog.

It is a further object of the present invention to disclose a system as define above, wherein said server further configured to send a request to said database to get the latest digital content catalog.

It is a further object of the present invention to disclose a system as define above, wherein said database further configured to returned said latest digital catalog to said server

It is a further object of the present invention to disclose a system as define above, wherein said server further configured to returned said latest digital catalog to said digital content market or said communication device.

It is a further object of the present invention to disclose a system as define above, wherein said sending unit further configured to enabled a user to selects content through his communication device or through said central digital content market, and to request from said server permissions to use them.

It is a further object of the present invention to disclose a system as define above, wherein said request is done after said digital content market or said communication device instructs a user to perform various tasks that will grant him these permissions.

It is a further object of the present invention to disclose a system as define above, wherein said various tasks are selected from a group consisting of payment, share with friends, providing rating, providing feedback, twitter, posting, distribute the app and/or publish the app, register to a subscription and/or plan and/or coupons, and any combination thereof.

It is a further object of the present invention to disclose a system as define above, wherein said server further configured to determined that all said terms and said prerequisites tasks were completed.

It is a further object of the present invention to disclose a system as define above, wherein said server further configured to perform a database request for marking a digital content as permitted and available for use for the user's notification personalization and to return said permissions approval to said digital content market or said communication device, after successfully marking said permission approval in the database.

It is a further object of the present invention to disclose a system as define above, wherein said computerized system further configured to enabled a user to create or use his own digital content for his notification personalization.

It is a further object of the present invention to disclose a system as define above, wherein said uploading unit further configured to enabled said digital content market or said communication device to send said digital content itself and its meta-data to said server for saving it for future use.

It is a further object of the present invention to disclose a system as define above, wherein said server further configured to process said digital content and to saves said digital content meta-data on said database and said digital content on said digital content storage.

It is a further object of the present invention to disclose a system as define above, wherein said sending unit further configured to send said notification to all listeners including said notification listener [420] in said communication device and to a system listener in said server [130].

It is a further object of the present invention to disclose a system as define above, wherein said sending unit further configured to determine to which communication devices to pass on said notification according to a notification personalization definitions.

It is a further object of the present invention to disclose a system as define above, wherein said sending unit further configured to enable a user to sends said notification with personalized notification to a non-system user, thereby controlling said notification personalization in the receiver side.

It is a further object of the present invention to disclose a system as define above, wherein said receiving unit module further configured to enable said non-system user to experience said notification personalization via performing an action on said received notification.

It is a further object of the present invention to disclose a system as define above, wherein said action selected from a group consisting of: clicking on a link in the notification to view said digital content on a web site, or clicking on a link to download said needed application and become a system user.

It is a further object of the present invention to disclose a system as define above, wherein said receiving unit adapted for retrieving said digital content from said digital content storage [310] or from said external digital content source [510].

### BRIEF DESCRIPTION OF THE DRAWINGS

In order to better understand the invention and its implementation in practice, a plurality of embodiments will now be described, by way of non-limiting example only, with reference to the accompanying drawings.

FIG. 1 shows a block diagram of an exemplary Pops system for personalizing a notification message, illustrates a scenario of a user viewing a digital content and acquiring permission to use it, in accordance with some exemplary embodiments of the disclosure;

FIG. 2 shows a block diagram of an exemplary Pops system for personalizing a notification message, illustrates a scenario of a user creating or using his own digital content, in accordance with some exemplary embodiments of the disclosure;

FIG. 3 shows a block diagram of an exemplary Pops system for personalizing a notification message, illustrates a scenario of a user creating or using his own digital content on more than one communication device or wishes to share it with his contacts, in accordance with some exemplary embodiments of the disclosure;

FIG. 4 shows a block diagram of an exemplary Pops system for personalizing a notification message, illustrates a scenario of a user receiving a notification on communication device and notification personalization is presented while all data exists already on communication device in accordance with some exemplary embodiments of the disclosure;

FIG. 5 shows a flowchart diagram of an exemplary Pops system for personalizing a notification message, illustrates a scenario of a user receiving a notification on communication device and notification personalization is presented—using an external digital content source [510], in accordance with some exemplary embodiments of the disclosure.

FIG. 6 shows a block diagram of an exemplary Pops system for personalizing a notification message, illustrates a scenario of a user receiving a notification on communication device and notification personalization is presented—using the digital content stored on the digital content storage, in accordance with some exemplary embodiments of the disclosure.

FIG. 7 shows a block diagram of an exemplary Pops system for personalizing a notification message, illustrates a scenario of a user receiving a notification on the server, and notification personalization is presented in accordance with some exemplary embodiments of the disclosure.

FIG. 8 shows a block diagram of an exemplary Pops system for personalizing a notification message, illustrates a scenario of a user initiating a notification through a communication device in accordance with some exemplary embodiments of the disclosure.

FIG. 9 shows a block diagram of an exemplary Pops system for personalizing a notification message, illustrates a scenario of a user receiving a notification and replies it, in accordance with some exemplary embodiments of the disclosure.

FIG. 10 shows a block diagram of an exemplary Pops system for personalizing a notification message, illustrates a scenario of a user sending a notification to a system user and personalize it, in accordance with some exemplary embodiments of the disclosure.

FIG. 11 shows a block diagram of an exemplary Pops system for personalizing a notification message, illustrates a scenario of a user sending a notification with personalized notification to a non-system user, in accordance with some exemplary embodiments of the disclosure.

FIG. 12 shows a block diagram of an exemplary Pops system for personalizing a notification message, illustrates a scenario of a user initiates or replies to a notification with notification personalization created or uploaded by the user, sent to a system user, in accordance with some exemplary embodiments of the disclosure.

FIG. 13 shows a block diagram of an exemplary Pops system for personalizing a notification message, illustrates a scenario of a user initiate or replies to a notification with personalized notification created or uploaded by the user, sent to a non-system user, in accordance with some exemplary embodiments of the disclosure.

FIG. 14 shows a block diagram of an exemplary Pops system for personalizing a notification message, illustrates a scenario of a publisher upload a new digital content to the system to be used by the system users, in accordance with some exemplary embodiments of the disclosure.

FIG. 15 shows a block diagram of an exemplary Pops system for personalizing a notification message, illustrates a scenario a publisher views digital content usage, publisher view the digital content usage in the content management and can view digital content statistics, transaction and usage, in accordance with some exemplary embodiments of the disclosure.

### DETAILED DESCRIPTION OF PREFERRED EMBODIMENTS

The following description is provided, along all chapters of the present invention, so as to enable any person to make use of said invention and sets forth the best modes contemplated by the inventor of carrying out this invention. As is customary, it will be understood that no limitation of the scope of the invention is thereby intended. Further modifications will remain apparent to those skilled in the art.

The term “user” refers hereinafter to a person which wishes personalize its received notifications or personalize the notification it is creating on other users, entities or communication devices

The term “partner” refers hereinafter to a business entity which wishes to provide a notification personalization service to its customers, by using the pops system/application service as is or branded on its own or co-branded or otherwise branded, or as part or bundled with its other services it provides its customers. Partner may control on the features of the notification personalization service and/or the digital content they provide under this service

The term “publisher” refers hereinafter to a digital content provider that provides digital content which will be provided to the users for notification personalization. The publisher may control on which partners or users can use the digital content under the notification personalization service, may add, edit or remove digital content, and may be exposed the digital content usage. Examples include media and movie companies, private animators, movie makers, song writers etc.

The term “communication device” refers hereinafter to any electrical or electronic or digital or computerized device that can received and/or present and/or create a notification. This includes all types of computers, mobile devices, tablets, any device that has a computerized component within, etc.

The term “contact” refers hereinafter to a notification initiator or receiver, which, by using a communication device and a notification providing service, can initiate or receive a notification. This includes users, non-system users which initiate or receive a notification from/to a system user, any application, service, software, system or other that provides a notification for a user. Examples includes a user which send a message on an sms, Instant messaging, mails or any other Internet based messaging system. More example are information provided by a communication device or a company or a service, like a computer battery status, a subscription ending alert, traffic and weather reports, calendar events, or municipal alerts.

The term “notification service” refers hereinafter to a system or software or platform or communication device that can technically provide data to a user on a communication device. This can include interne based services like mail services, sms, operating systems, and also include information providing services like facebook, twitter etc.

The term “notification” refers hereinafter to an alert on new or changed information, or on an event that has occurred, a reminder or subscription that is due, and any other information that is being passed to the user. This includes mails, sms, twitter or facebook message, calender events, user or service or company status changes etc. Notification and notification data includes not only the alert on a new event, but also actual details of the event—e.g. in mail—the sender, the subject, the body, CC and BCC etc.

The term “digital content” refers hereinafter to any digital media or content that can be presented or played to a user on a communication device. This includes video, audio, images, text, music, web content, animation, whole or part of movies, TV content or any other information that can be provided to a user on a communication device. Digital content may be created or edited by the publisher or by the user itself e.g. user may use a mobile video camera to take a video that will be played when a notification is received or sent.

The term “digital content catalog”—refers hereinafter to a digital content available for user in the system. Publishers upload digital content to the system, set the needed terms of use (payment, restrictions etc). User can browse this digital content catalog and request permissions to use one or more of the digital content for his notification personalization. Permission are granted after user has fulfilled the needed terms e.g. payment, subscription, performing various tasks like inviting friends to join the service, sharing on facebook or rating the application in various distribution sites.

According to some embodiments there is provided a pops system/application, a system for providing different types of services for personalizing notifications received or initiated by a user on a communication devices from contact.

According to some embodiments, the Pops system provides a user with a service to personalize his received and initiated notification to other contacts on their communication devices. Thereby, the user may personalize his received notifications by choosing a digital content definitions to be presented once a notification appears on the contact communication devices that receives the notification, according to various information provided from the notification itself (the initiating contact details of the notification, the notification details itself e.g. text), user profile and details, time, date, holidays and events and any other accessible information.

According to another embodiments, the user may initiated a notification by choosing a digital content definitions to be presented once a notification appears at the contact which receives the notification, the sender user provided with the ability to choose a digital content according to various information provided from the notification itself (the initiating contact details of the notification, the notification details itself e.g. text), user profile and details, time, date, holidays and events and any other accessible information. Thus, control the notification personalization on the contact that receives the notification.

According to other embodiments the digital content comprises a personal signature. For example, sending digital content that represents the sender's personality, occupation, actions, hobbies etc. controlling on notification personalization by the sender, can be used to sign and set a personal note to a notification.

According to other embodiments, the notification personalization may be a video taken and sent to a contact to share an experience or event, or a quick reply animation or video that relates a message like “will contact you in 5 minutes”.

According to other embodiments the user is provided, on the notification, with an encapsulation of functions, such as receiving and initiation functions both in user interface and experience, furthermore, the user provided with the ability to choose which notification service to use and cross notification services communication. Thereby enabling the user to view, received, and reply to notifications and initiate new notifications.

According to some embodiments, the user may be provided with a single user interface and experience for receiving and initiating notifications, without relevance to which notification service is used to receive or send the notification. For example, user can choose not to be informed weather an incoming notification is sms based of mail based, and reply to the notification using the same notification service, without the need to know or select which initiating notification service is used.

According to some embodiments, user is provided with the ability to relate and view full contact cross-notification service details information irrelevantly, to the notification service which used to received or initiate a notification. Thereby, on in coming notifications and on contact details, user can view all the contact notification service details like ids, addresses and other notification service specific contact data. For example, on receiving a mail notification, user can view the contact that initiated this notification with its full cross-notification service details like phone number, name, occupation, education and all other available cross notification service information available.

According to some embodiments, the cross service notifications communication enabled the user to choose, reply or initiate a notification in a different notification service which was used to initiate the notification. For example, user may choose to reply to an sms notification with a mail.

According to some embodiments, when receiving a personalized notification, user will view the personalized notification on his communication device (according to the user definition), even if the device is in sleep mode, idle mode, screen turned off, locked or any other battery saving or resource preserving state. The system will wake up the communication device to a fully active state and will present the digital content.

According to some embodiments, the Pops system may provide a publisher with a platform to upload, share, and sell digital content. The publisher provided with a platform to present and promote his digital content. Furthermore, the system may compensated the publisher on the usage of his digital content in the platform

According to some embodiments, the Pops system may provide users with the ability to personalize their notifications using a digital content created by the publisher.

According to some embodiments, the Pops system may further provide a partner the ability to use a notification personalization service and to provide it to his customers, with his own definitions and flavor. The partner may choose digital content to provide to his users, that may be exclusive, and to brand the personalization service under his brand, co-branded or other.

### System Components:

1. Digital content storage—store digital content. This component might be external or internal to the system, since digital content may be consumed from publishers systems and external services. This competent may be a Database (e.g oracle, MS Sql, My Sql, NoSql, cloud based Database etc.), a storage device/system (EMC, netapp, cloud based storage etc.). This component may also be a user specific storage like a computer hard disk, an SD card etc. this component may also be a CDN service, a public or an Internet digital content service or site or system (e.g. youtube, netflix etc.). digital content storage may also be part of the notification service—for example, digital content can be saved and retrieved for notifications using MMS, mail attachments, file uploads, and any other notification that support digital content sending and sharing.
   The aforementioned digital content may be presented upon digital content catalog in different ways—category based, search based, popular etc.
2. Database—user and service data, system records, digital content catalog data. Can be of any type of database or storage product including oracle, MS Sql, My Sql, NoSql, cloud based Database etc.), a storage device/system (EMC, netapp, cloud based storage etc.).
3. Digital content management—an interface for publisher and partners to upload and manage the digital content and user's notification personalization service. Can be an application, a web site etc.
4. Digital content market—an interface to allow the user to choose and purchase digital content for notification personalization. Including an application or a web site etc.
5. Communication device—display the digital content on notification according to user configuration. The communication device hosts a software, application, web pages, scripts or other runnable logic which is part of the system.
6. Notification services listener—connects to the notification services and allow the initiation of the notification personalization presentation on time of the notification. For example, a facebook software which allows receiving facebook messages.
7. Notification routing—cross-notification service routing. allows a notification to be routed between notification services according to the user's definitions. For example—a user may choose to get all his smses as mails, and the cross-notification service routing will get the sms from the sms notification service using the notification service listener, transform it to an email, and use the email notification service to send the email
8. server—a centralized host for the system components. The server components can be of any type of generic server, web server that can run compiled or scripted logic. e.g. apache, tomcat, ngnix, IIS, etc.
9. notification service—a system or software or platform or communication device that can technically provide data to a user on a communication device, it is usually an external notification service like SMSC for smses, or facebook servers for facebook notifications, email servers etc. On the other hand, it may also be an internal notification server to pass system type notifications (e.g. two system users may choose to pass a notification using only an internal type notification type, and not use an external notification service.

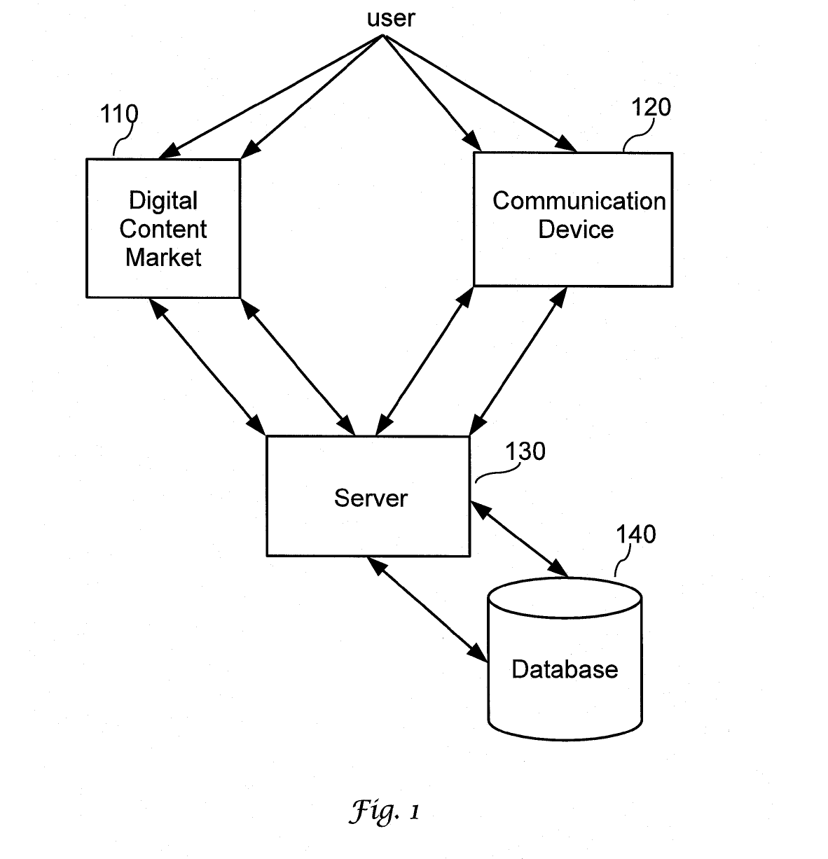

Reference is made now to FIG. 1 which shows a block diagram of an exemplary Pops system for personalizing a notification message, which illustrates non-limiting examples of typical embodiments of a user viewing a digital content and acquiring permission to use it.

In the first step: A user view publishers uploaded content through his communication device [120] or through a central digital content market [110] e.g. a digital content marker website. Digital content may be presented in different ways—category based, search based, popular etc. The user can select one or more digital content items and request permissions to use them for his notification personalizations on one or more communication devices.

In the next step, the digital content market [110] or the communication device [120] performed a server [130] request to get the latest digital content catalog. The server [130] returns the digital content catalog data.

In the next step, the server [130] performs a database[140] request to get the latest digital content catalog. The Database[140] returns the latest digital catalog data to the server [130] and the server further returned the latest digital catalog to the digital content market [110] or communication device [120].

In the next step, the user selects one or more digital content items from the presented digital content in the digital content market or on his communication device, and request permissions to use them in his notification personalization. The request is done after the digital content market or the communication device instructs the user to perform various tasks that will grant him these permissions—e.g. payment, share with friends etc. On the other hand, the task might also be just doing nothing thereby getting the content for free.

In the next step, the digital content market [110] or the communication device [120] performs a server [130] request to get permissions on the requested digital content items.

In the next step, the server [130] makes sure all terms and prerequisites tasks were completed (e.g payment, sharing). The server [130] then performs a Database request [140] to mark the digital content as permitted and available for use for the user's notification personalization. The server [130] then returns the permissions approval to the digital content market [110] or the communication device [120], after successfully marking the permission approval in the Database[140].

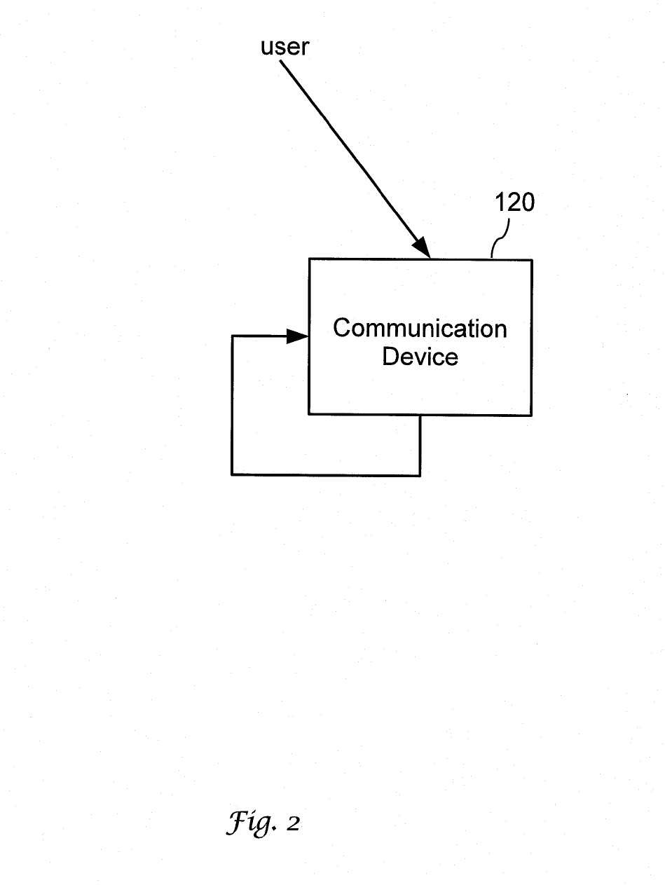

Reference is made now to FIG. 2 which shows a block diagram of an exemplary Pops system for personalizing a notification message, which illustrates a non-limiting examples of typical embodiments of a user creating or using his own digital content.

User may choose to create or use his own digital content for his notification personalization. For example—user may create content using his camera, using a homemade video or image, or composing text. User can choose to use this own created digital content on his own communication device, or to be presented on his contact communication device on the user's initiated or replied notifications, or to share the digital content using the system.

In the first step, a user chooses any digital content existing or created on the communication device.

In the next step, the user provides the communication device with details on the digital content, including its location on the communication device storage or on an accessible external storage or service e.g. video and images from SD card, digital content web service or site, youtube, communication device camera etc. the communication device uses these digital content for the personalization notifications

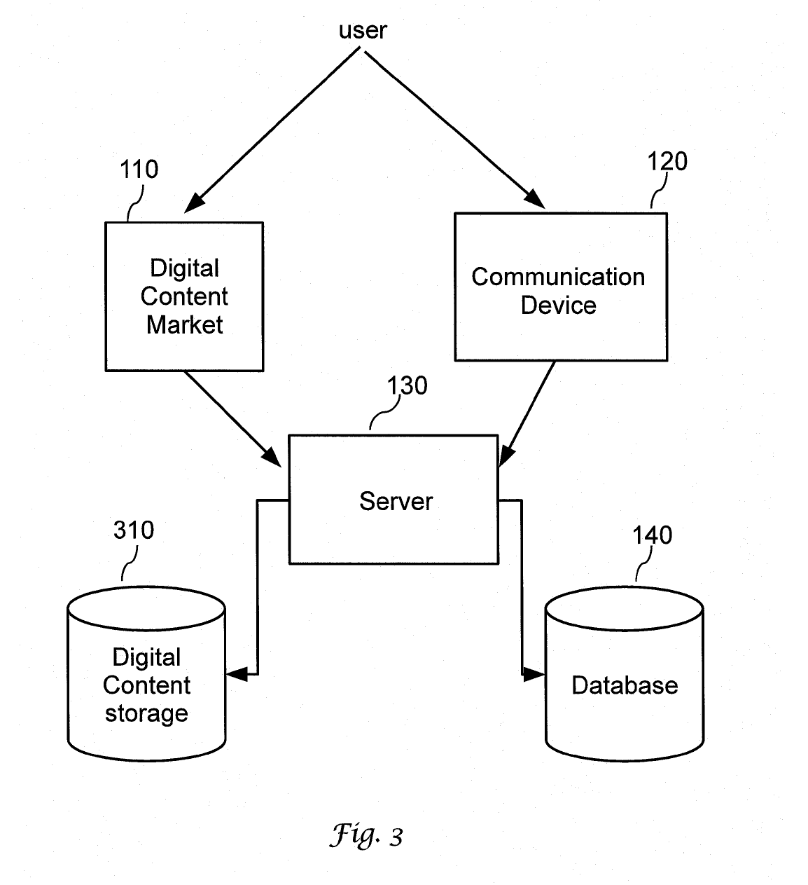

Reference is made now to FIG. 3 which shows a block diagram of an exemplary Pops system for personalizing a notification message, which illustrates a non-limiting examples of typical embodiments of a user creating or using his own digital content on more than one communication device or wishes to share it with his contacts.

In the first step, a user uploads a digital content to the digital content market [110] or communication device [120]. This content will be available for him to be used for his notification personalization.

In the next step, the digital content market [110] or communication device [120] is sending the digital content itself and its meta-data to the server [130] to save it for future use.

In the next step, the aforementioned server [130] may process the digital content (e.g. changes in format, quality or other). The server saves the digital content meta-data on the Database[140] and the digital content on the digital content storage [310], thus enabling future retrieval and usage of the digital content on any communication device and any user, according to permissions and service definitions.

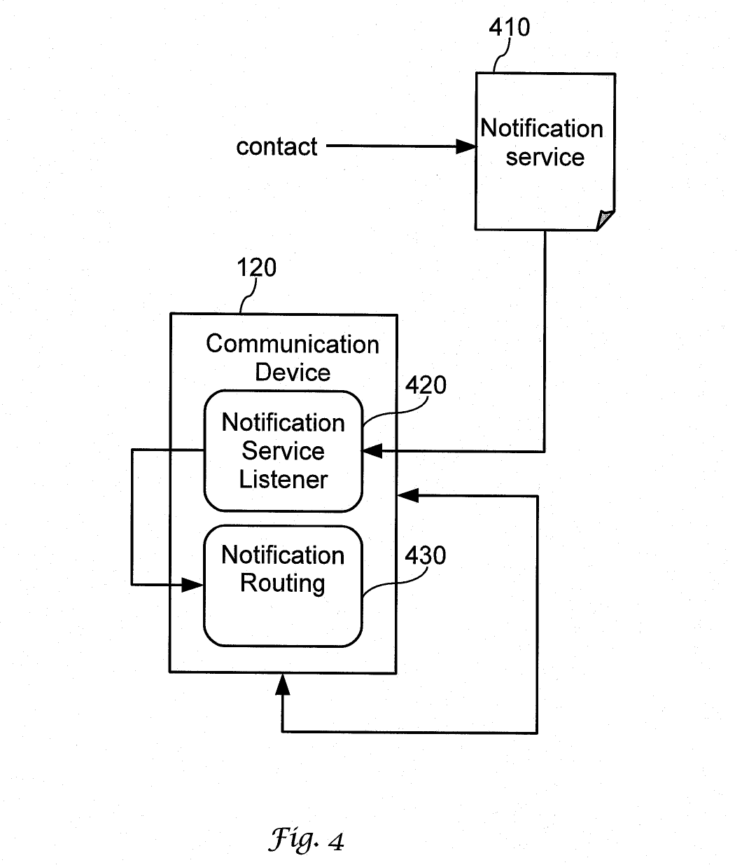

Reference is made now to FIG. 4-7 which shows a block diagram of an exemplary Pops system for personalizing a notification message, which illustrates a non-limiting examples of typical embodiments of a user receiving a notification to his communication device or to one his notification services and he then requested to have notification personalization on.

The communication device will then present one or more digital content according to user's configured choice, partner or product choice etc. according to the notification personalization definitions. User may or may not have some or all needed digital content or notification personalization or other needed data for deciding what digital content to present, and thus the communication device will perform a server [130] request to complete the data, to retrieve the digital content (e.g download, stream, other) etc. after acquiring all needed digital content and information, digital content is presented, with the notification data and all other data as defined in the notification personalization.

Reference is made now to FIG. 4 which illustrates a non-limiting examples of typical embodiments of a user receiving a notification on communication device and notification personalization is presented while all data exists already on communication device.

In the first step, a contact initiates or replies on a notification through one of the notification services [410] which the user has requested to personalize notifications on.

In the next step, the notification service [410] is sending the notification to all listeners, including the notification listener [420] in the communication device [120].

In the next step, the notification is passed to the cross-notification service routing component [430], that according to the notification personalization definitions, decides to which communication devices to pass on the notification (including the current hosting one). This may include changes in the notification data, including type (e.g. cross-notification service routing may decide to change to an email on a received sms notification), sending to several other communication devices and/or users (e.g. group sending, notification forwarding etc.) etc.

In the next step, the notification personalization is presented upon the user communication device according to the user's configured definitions, the notification data etc.

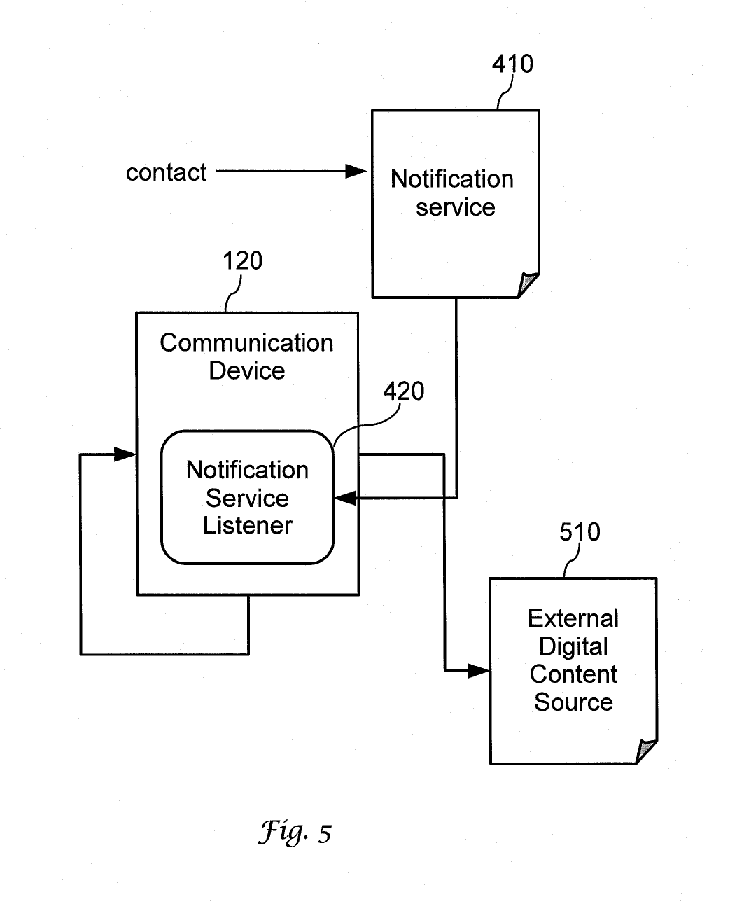

Reference is made now to FIG. 5 which illustrates a non-limiting examples of typical embodiments of a user receiving a notification on communication device and notification personalization is presented—using an external digital content source [510].

In the first step, a contact initiates or replies on a notification through one of the notification services [410] the user has requested to personalize notifications on.

In the next step, the notification service is sending the notification to all listeners, including the notification listener [420] in the communication device [120].

In the next step, according to the notification personalization definitions, additional digital content is needed to be presented, the communication device [120] request for additional digital content from an external digital content source [510]. (e.g youtube). Content is retrieved (downloaded, streamed etc.)

In the next step, notification personalization is presented according to the user's configured definitions, the notification data etc.

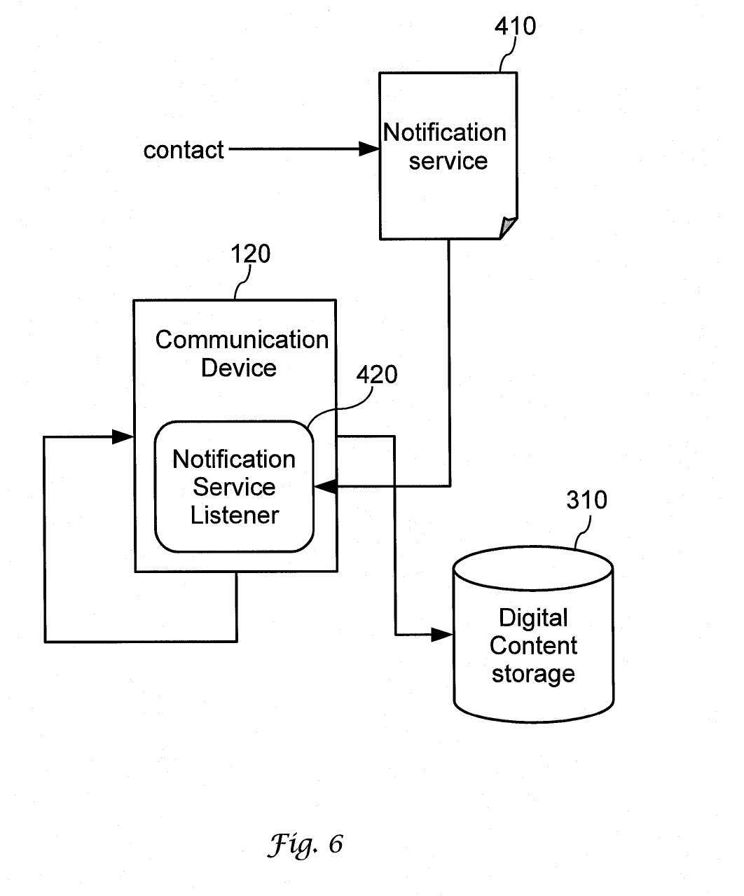

Reference is made now to FIG. 6 which illustrates a non-limiting examples of typical embodiments of a user receiving a notification on communication device and notification personalization is presented—using the digital content stored on the digital content storage [310].

In the first step, a contact initiates or replies on a notification through one of the notification services [410] the user has requested to personalize notifications on.

In the next step, the notification service [410] is sending the notification to all listeners, including the notification listener [420] in the communication device [120].

In the next step, according to the notification personalization definitions, additional digital content is needed to be presented, the communication device request for additional digital content from the digital content storage [310]. Content is retrieved (downloaded, streamed etc.)

In the next step, the notification personalization is presented according to the user's configured definitions, the notification data etc.

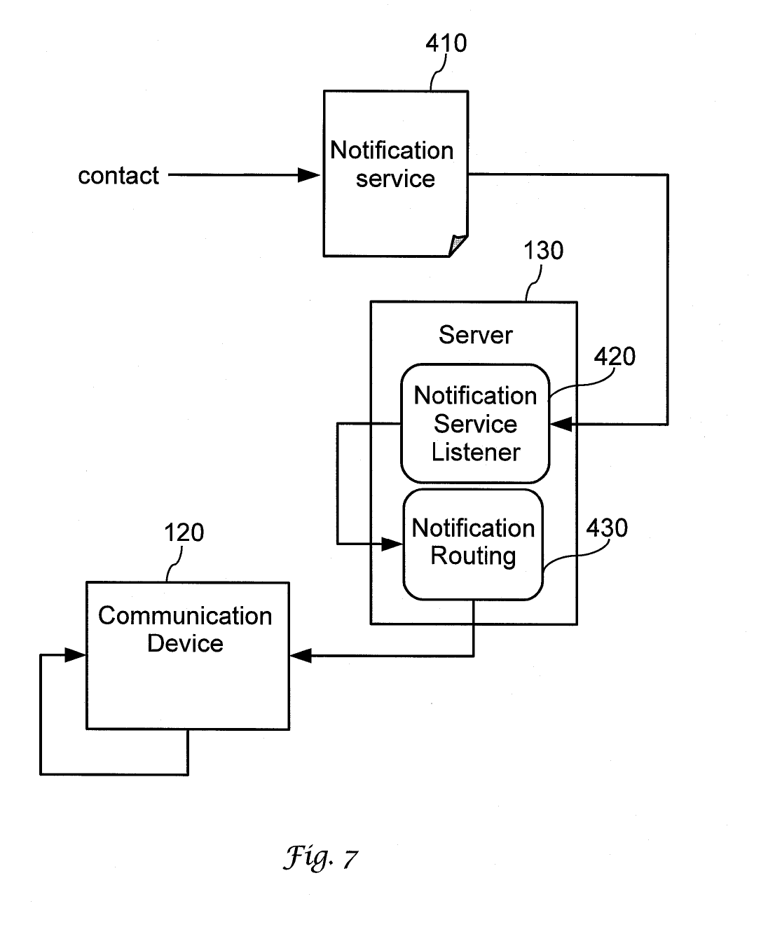

Reference is made now to FIG. 7 which illustrates a non-limiting examples of typical embodiments of a user receiving a notification on the server, and notification personalization is presented

In the first step, a contact initiates or replies on a notification through one of the notification services [410] the user has requested to personalize notifications on.

In the next step, the notification service is sending the notification to all listeners, including the system listener in the server [130].

In the next step, the notification is passed to the cross-notification service routing component [430] that according to the notification personalization definitions, decides to which communication devices to pass on the notification. This may include changes in the notification data, including type (e.g. cross-notification service routing [430] may decide to send an email on a received sms notification), sending to several communication devices and/or users (e.g. group sending, notification forwarding etc.) etc.

In the next step, the notification personalization is presented according to the user's configured definitions, the notification data etc.

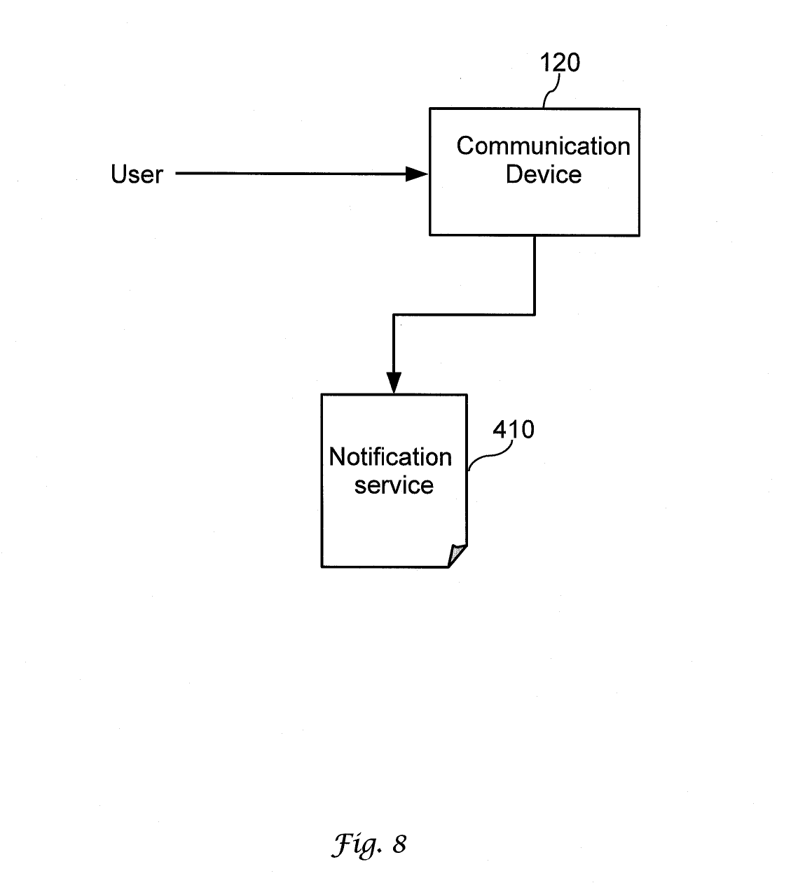

Reference is made now to FIG. 8 which illustrates a non-limiting examples of typical embodiments of a user initiating a notification through a communication device

In the first step, a user chose to initiate a notification or an action that will cause a notification in the communication device [120]. This can be done using the system user interface or with any other communication device capability or application that can create a notification. User may decide to select the type of notification service he wishes to use, or let the system choose for him;

In the next step, the communication device passes the notification to the notification service, which will in his turn, send the notification as a regular notification.

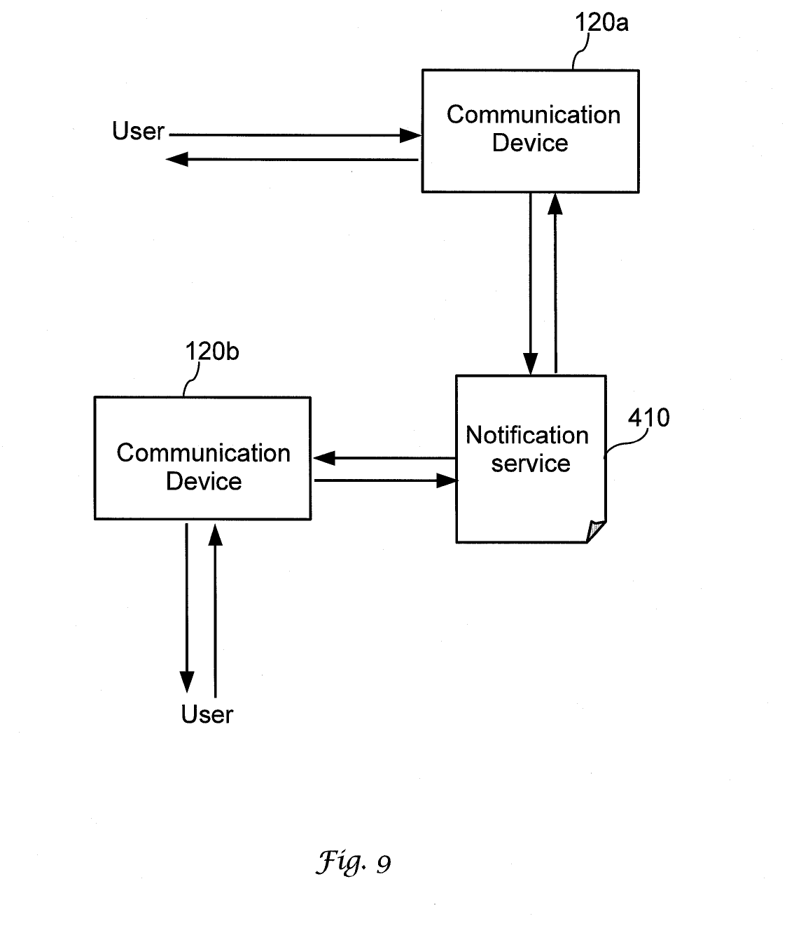

Reference is made now to FIG. 9 which illustrates a non-limiting examples of typical embodiments of a user receiving a notification and replies it.

In the first step, a user initiates a notification in the communication device [120a]

In the next step, the communication device sends a notification to the notification service [310]

In the next step, the notification service routs the notification to the destination user/s communication device/s [120b]

In the next step, the notification presented according to notification personalization definitions

In the next step, the user chooses to reply to the notification

In the next step, the communication device [120b] sends a notification to the notification service [310]

In the next step, the notification service route the notification to destination user's communication devices [120a]

In the next step, the notification is presented according to notification personalization definitions

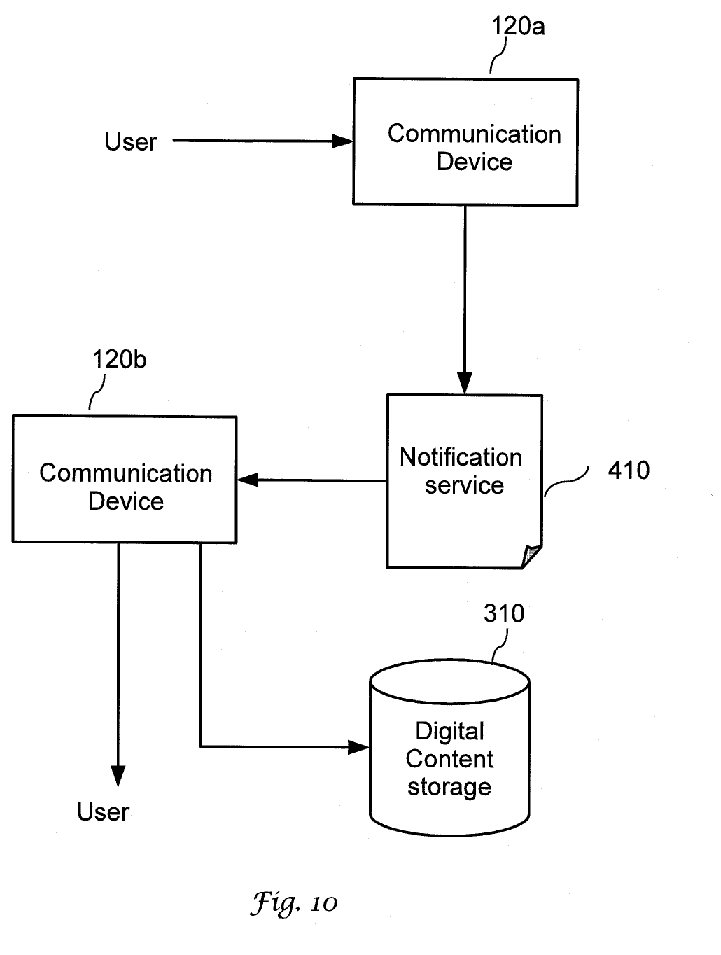

Reference is made now to FIG. 10 which illustrates a non-limiting examples of typical embodiments of a user sending a notification to a system user and personalize it, so he enable to controls the notification personalization in the receiver side. For example—sending a notification with a video which is a personal signature of the sender, an avatar or a social or business profile. Another example maybe sending a movie to replace or add to a notification—like a “busy, will talk to you later” movie etc.

In the first step, a user initiates a notification in the communication device [120a] and chooses the notification personalization including the digital content to present on the notification receiver communication device.

In the next step, the communication device sends the notification and the notification personalization data to the notification service [310].

In the next step, the notification service [310] routs the notification to the destination user's communication devices

In the next step, the communication device receives the notification and the notification personalization data and retrieves (download, stream, etc) the needed digital content form the digital content storage [310] or external digital content source [510].

In the next step, the notification presented according to notification personalization definitions.

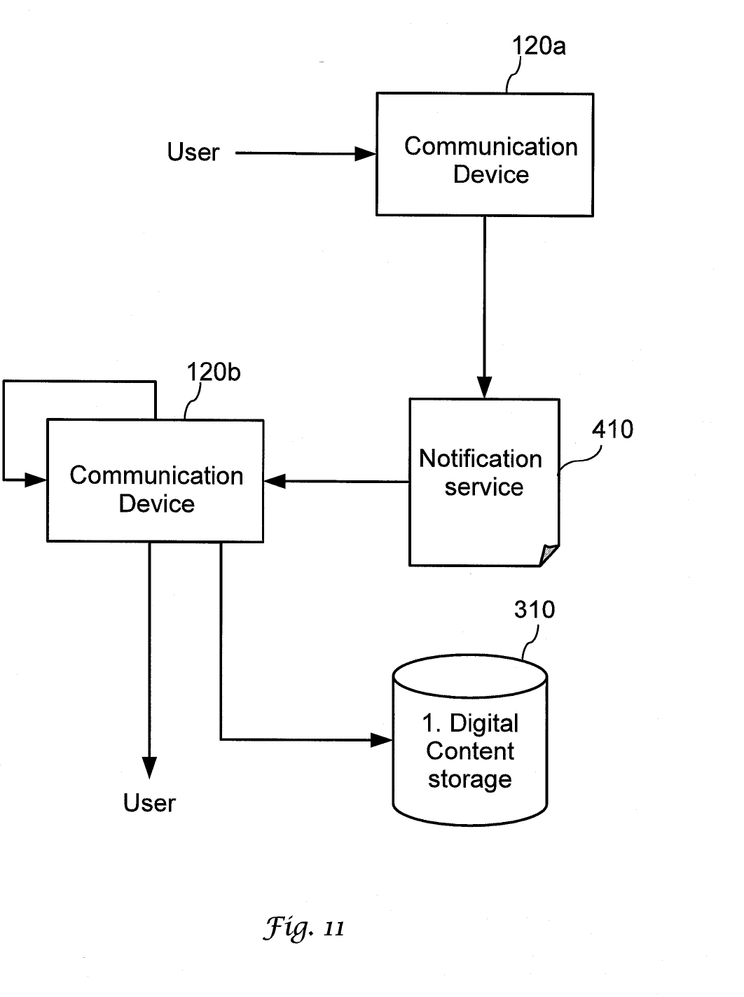

Reference is made now to FIG. 11 which illustrates a non-limiting examples of typical embodiments of a user sends a notification with personalized notification to a non-system user so he controls the notification personalization in the receiver side. For example—sending a notification with a video which is a personal signature of the sender, an avatar or a social or business profile. Another example maybe sending a movie to replace or add to a notification—like a “busy, will talk to you later” movie etc. in case the receiver of the notification does not have the needed system component on his communication device, the user will be prompt to perform an action so he could experience the notification personalization. For example this action can be clicking on a link, downloading an application etc.

In the first step, a user initiates a notification in the communication device [120a] and chooses the notification personalization including the digital content to present on the notification receiver communication device [120b].

In the next step, the communication device sends the notification and the notification personalization data to the notification service [310]

In the next step, the notification service routs the notification to the destination user's communication devices [120b]

In the next step, a non-system user performs an action on the received notification, to allow him to experience the notification personalization. For example, clicking on a link in the notification to view the digital content on a web site, or clicking on a link to download the needed application and become a system user.

In the next step, communication device retrieves (download, stream, etc) the needed digital content form the digital content storage [310] or external digital content source [510].

In the next step, notification presented according to notification personalization definitions

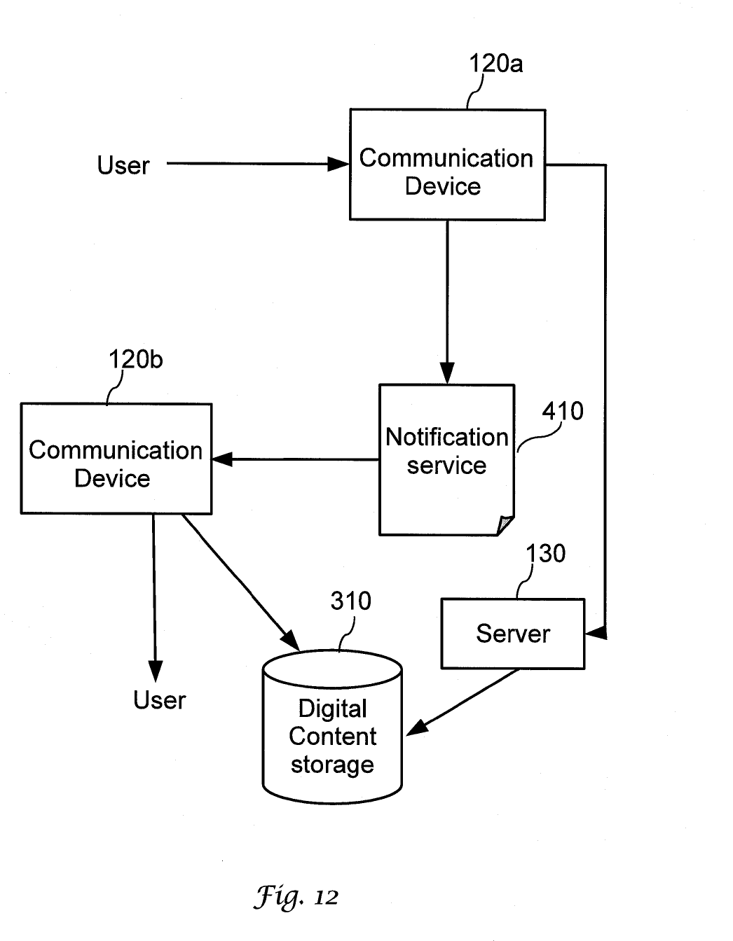

Reference is made now to FIG. 12 which illustrates a non-limiting examples of typical embodiments of a user initiate or replies to a notification with notification personalization created or uploaded by the user, sent to a system user, user sends a notification and personalize it using his digital content, so he controls the notification personalization in the receiver side. For example, sending a notification with a video taken from a camera.

In the first step, a user creates or uploads digital content he wishes to use in the notification personalization of the notification sent to other user/s and communication device/s. the user initiates a notification in the communication device [120a] and chooses the notification personalization including the user created digital content to present on the notification receiver communication device [120b].

In the next step, the communication device uploads user created digital content to the server [130]. The communication device may also use the notification service [310] for that purpose, for example attaching the digital content to a mail, or sending an mms, share a file etc.

In the next step, the server [130] saves the user created digital content in the digital content storage [310].

In the next step, the communication device [120a] sends the notification and the notification personalization data to the notification service [310].

In the next step, the notification service routs the notification to the destination user's communication device [120b]

In the next step, the communication device [120b] receives the notification and the notification personalization data and retrieves (download, stream, etc) the needed digital content form the digital content storage [310] or external digital content source [510].

In the next step, the notification presented according to notification personalization definitions

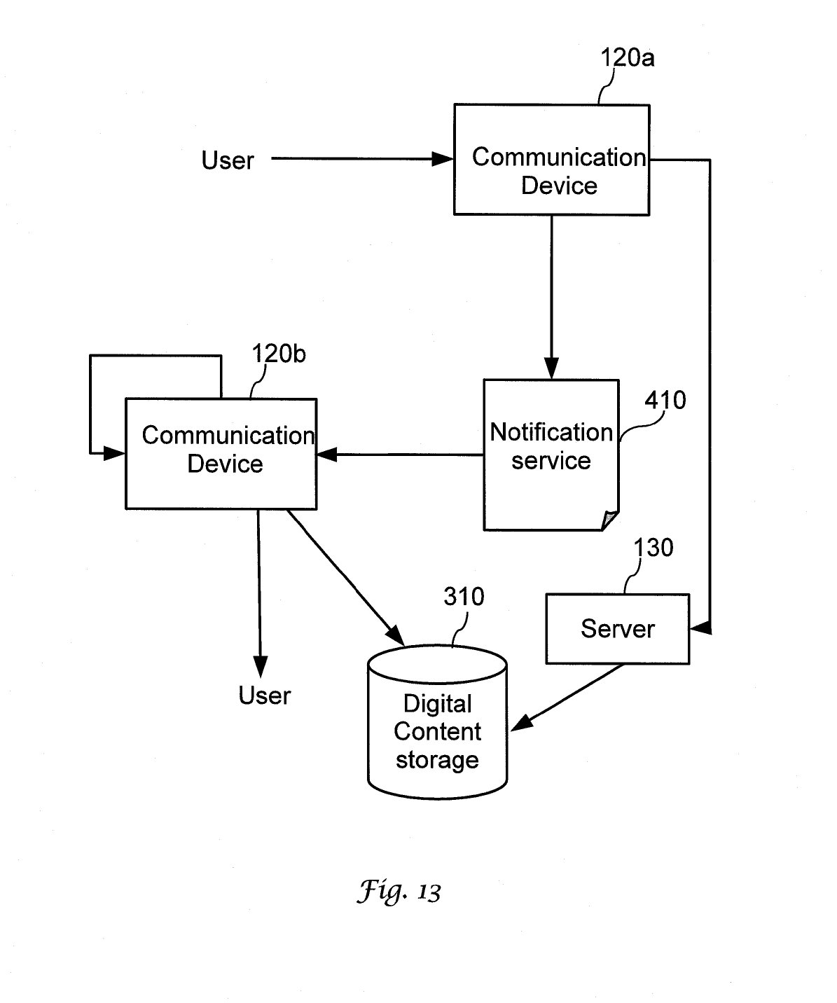

Reference is made now to FIG. 13 which illustrates a non-limiting examples of typical embodiments of a user initiate or replies to a notification with personalized notification created or uploaded by the user, sent to a non-system user, user sends a notification and personalizes it, so he controls the notification personalization in the receiver side. For example—sending a notification with a video created by the camera. Another example maybe sending a video to replace or add to a notification—like a “look at my new car” video etc. in case the receiver of the notification does not have the needed system component on his communication device, the user will be prompt to perform an action so he could experience the notification personalization. For example this action can be clicking on a link to view the digital content in a website, downloading an application etc.

In the first step, a user creates or uploads digital content he wishes to use in the notification personalization of the notification sent to other user/s and communication device/s. the user initiates a notification in the communication device [120a] and chooses the notification personalization including the user created digital content to present on the notification receiver communication device [120b].

In the next step, the communication device uploads user created digital content to the server [130]. The communication device may also use the notification service [410] for that purpose, for example attaching the digital content to a mail, or sending an mms, share a file etc.

In the next step, the server [130] saves the user created digital content to the digital content storage [310]

In the next step, the communication device [120a] sends the notification and the notification personalization data to the notification service [410]

In the next step, the notification service [410] routs the notification to the destination user/s communication device/s [120b]

In the next step, a non-system user performs an action on the received notification, to allow him to experience the notification personalization. For example, clicking on a link in the notification to view the digital content on a web site, or clicking on a link to download the needed application and become a system user.

In the next step, the communication device retrieves (download, stream, etc) the needed digital content form the digital content storage [310] or external digital content source [510].

In the next step, the notification presented according to notification personalization definitions

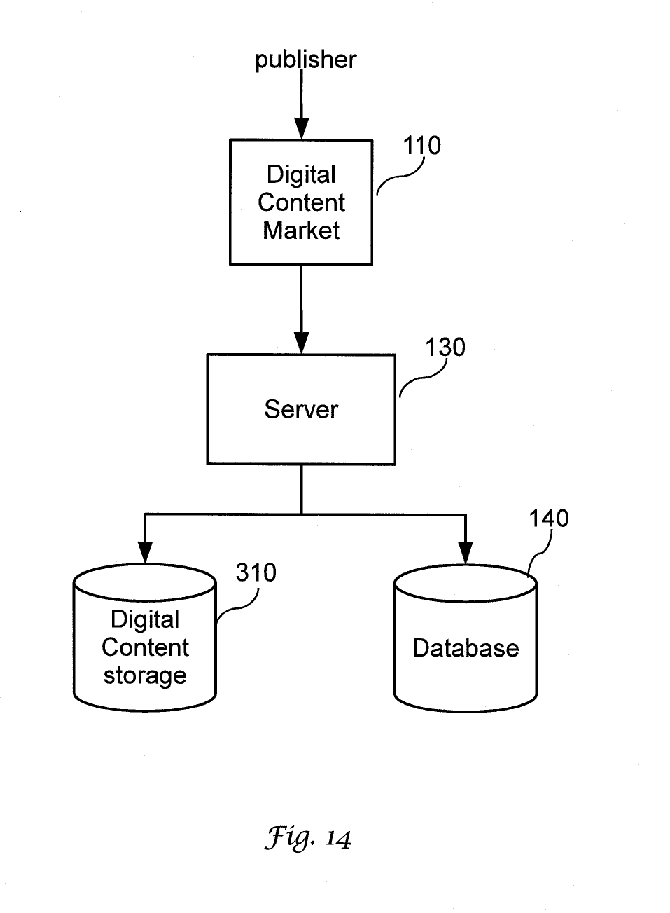

Reference is made now to FIG. 14 which illustrates a non-limiting examples of typical embodiments of a publisher upload a new digital content to the system to be used by the system users

In the next step, a publisher authenticates with digital content management

In the next step, the publisher uploads new or changes digital content and metadata to the server [130]

In the next step, the server [130] saves metadata changes to the Database[140] including the digital content location

In the next step, the server [130] saves digital content to the digital content storage [310]

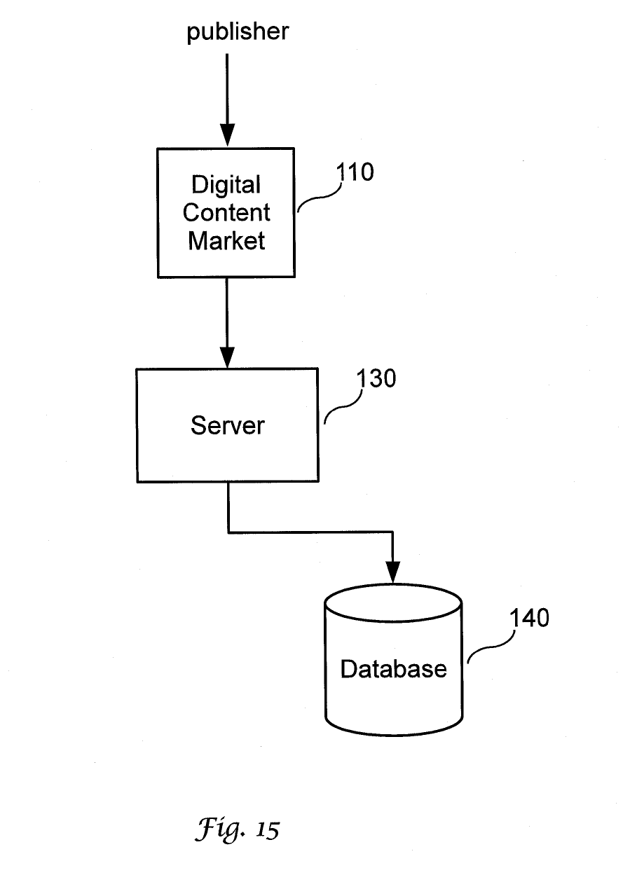

Reference is made now to FIG. 15 which illustrates a non-limiting examples of typical embodiments of a publisher views digital content usage, publisher view the digital content usage in the content management and can view digital content statistics, transaction and usage.

In the next step, a publisher authenticates with digital content management, and request to view digital content statistics

In the next step, the content management system retrieves the digital content usage statistics from the server [130]

In the next step, the server [130] retrieves the digital content usage statistics from the database[140]

1-86. (canceled)

87. A computerized system for personalizing a notification comprising
a. a communication device for display a digital content on notification [120]
b. a computer readable medium comprising one or more functional modules including
i. a receiving unit for enabling a user to personalized his incoming notification;
ii. a sending unit for enabling a user to personalized his outgoing notification.
iii. an uploading unit for enabling a user and/or publisher to upload a digital content;
iv. a downloading unit for enabling a user to downloaded a digital content.
Wherein said communication device configured to utilized said units for personalized an outgoing and incoming notification, for presenting said personalized notification on said contact communication device, and for enabling transactions regarding ordering and purchasing said digital content.

88. The computerized system of claim 87, wherein said computerized system configured to be an app and/or a web site running on a communication device.

89. The computerized system of claim 87, wherein at least one of the following is being held true (a) said receiving unit comprising: a notification service module, a notification listener module and, a cross-notification service routing module, a digital content source and a digital content storage; (b) said sending unit comprising: a notification service module, and a digital content storage, a notification listener module and, a cross-notification service routing module, and a digital content source; (c) said uploading unit comprising: a digital content market, a database, a digital content storage, a server; (d) said downloading unit comprising: digital content market, server, database and a digital content storage; and any combination thereof.

90. The computerized system of claim 87, wherein said communication device selected from a group consisting of: electronic, digital, and computerized device adapted for receiving and presenting and/or creating a notification.

91. The computerized system of claim 87, wherein said notification comprises information which configured to pass to a user; further wherein said information configured to be passed to a user via said notification service; further wherein said notification service further comprises detailed information of said event and selected from a group consisting of: sms, email, Instant Messaging services, Social services, twitter or facebook message, calendar events, user or service or company status changes, Cloud based services, operating systems, third party applications—calendar, wakeup call and any other suitable notification service known in the art.

92. The computerized system of claim 87, wherein said notification selected from a group consisting of: an alert on new or changed information, an event, a reminder or subscription that is due.

93. The computerized system of claim 87, wherein said digital content comprises a digital media and/or content configured to be presented and/or played onto a user said communication device; further wherein said digital media are selected from a group consisting of: video, audio, images, text, music, web content, animation, whole or part of movies, TV content or any other suitable means known in the art.

94. The computerized system of claim 87, wherein at least one of the following is being held true (a) said digital content further comprises at least one advertisement; (b) said digital content is further configured to be promoted in the digital content catalog by a publisher and/or an advertiser; (c) said digital content further comprises additional content added on top of and/or as part of said digital content; (d) said digital content configured to be created or edited by a publisher or by a user itself; (e) said digital content further configured to be track-able and measured for payment of an advertiser; wherein said measured is executed by measures selected from a group consisting of: cost per click, cost per view, cpm, cpv and any other suitable tracking ad measures known in the art; and any combination thereof.

95. The computerized system of claim 87, wherein at least one of the following is being held true (a) said additional content selected from a group consisting of: advertisements, external links, videos, text, and localized content; further wherein said localized content is configured to be events and/or weather information; (b) said digital content comprises personal features; further wherein said personal features selected from a group consisting of: signature, an avatar, a personal representation of a person, and an organization representation; and any combination thereof.

96. The computerized system of claim 87, wherein said digital content configured to be presented via digital content catalog in several different ways; further wherein at least one of the following is being held true (a) said different ways of presentation comprising category based, search based, popular and any other conventional presentations known in the art; (b) said ways of catalog presentation configured to be defined according to characteristic selected from a group consisting of: localization, partner, publisher, distribution channel, and a user profile and/or characteristics.

97. The computerized system of claim 87, wherein at least one of the following is being held true (a) said downloading unit further comprising a digital content catalog configured to presented available said digital content for user in the system; (b) said digital content storage adapted for storing said digital content; (c) said digital content storage further configured to be internal and/or external digital content storage to the computerized system; (d) said digital content storage selected from a group consisting of: database, a storage device/system, a user personal storage, CDN service, internet digital content service or site or system; (e) said digital content storage further configured to be part of said notification service; and any combination thereof.

98. The computerized system of claim 87, wherein external digital content storage configured to be consumed from publishers systems and/or external services; further wherein at least one of the following is being held true (a) said database selected from a group consisting of: oracle, MS Sql, My Sql, NoSql, cloud based Database and/or any other conventional means known in the art; (b) said storage device/system are selected from a group consisting of EMC, netapp, cloud based storage and/or any other conventional storage known in the art; (c) said user personal storage selected from a group consisting of: computer hard disk, an SD card, and/or any other conventional means known in the art; (d) said internet digital content service, site or system are selected from a group consisting of youtube, Netflix, and any other conventional means known in the art; (e) said external services further configured to be part of said notification service; wherein said part of said notification service comprises an MMS, mail attachments, file uploads, and any other conventional notification that support digital content sending and sharing that known in the art; (f) and any combination thereof.

99. The computerized system of claim 87, wherein at least one of the following is being held true (a) said database configured to stored data selected from a group consisting of: user and/or service data, system records, and said digital content catalog data; (b) said database selected from a group consisting of oracle, MS Sql, My Sql, NoSql, cloud based Database, EMC, netapp, cloud based storage and any other conventional database known in the art; and any combination thereof.

100. The computerized system of claim 87, wherein said uploading unit further comprising a digital content management module comprises an interface configured to enabling a publisher and/or partners to uploaded and managed said digital content and said user's notification personalization service; further wherein at least one of the following is being held true (a) said digital content management module further configured to be an application and/or a web site; (b) said digital content management module further configured to enabled a publisher to views said digital content data; (c) said digital content data selected from a group consisting of: statistics, transaction and usage; (d) communication device further configured to hosts a runnable logic which configured to be part of the system; further wherein said runnable logic is selected from a group consisting of: computer readable medium, application, web pages, scripts or other conventional runnable logic known in the art; and any combination thereof.

101. The computerized system of claim 87, wherein at least one of the following is being held true (a) said digital content market module comprises a user interface configured to allowed a user to choose and purchase said digital content for notification personalization; (b) said digital content market module configured to be an application and/or a web site; (c) said communication device adapted for displaying said digital content on a notification according to a user configuration; (d) said notification listener module adapted for connecting to a notification services and allowing an initiation of a notification personalization presentation on time of said notification; (e) said cross-notification service routing module configured to use an information of users and/or contacts for routing notification to user's communication device; (f) said receiving unit and wherein said sending unit are further comprising a server; (g) said notification service module further comprises an internal notification service; and any combination thereof.

102. The computerized system of claim 87, wherein said notification service further comprises an external notification service; further wherein said external notification service selected from a group consisting of: SMSC for smses, or facebook servers for facebook notifications, and email servers.

103. The computerized system of claim 87, wherein said computerized system operating in a method of:
a. receiving a notification with said associated digital content;
b. uploading and/or downloading said digital content, and;
c. identifying at least one characteristic of the notification, and;
d. associating a digital content with at least one of said characteristics of said notification;
e. displaying said digital content which associated with at least one characteristic according to notification personalization definitions; and
f. providing means for enabling user to choose which notification service to use by cross notification services communication.
g. sending said notification with said associated digital content to a receiver client.
h. enabling transactions regarding ordering and purchasing said digital content;
wherein said at least one characteristic selected from a group consisting of: contact, the content of said message, the message type, a service, notification data, user profile, initiating contact details of the notification, the notification details itself (e.g. text), user profile and details, time, date, holidays and events and any combination thereof.

104. The computerized system of claim 87, wherein at least one of the following is being held true (a) said receiving unit configured to provide a user interface and/or experience for receiving and initiating a notifications, regardless of which notification service is used to receive or send said notification; (b) said receiving unit further provided user the ability to relate and view full contact cross-notification service details information, irrelevantly to the notification service which used to received and/or initiate a notification; (c) said cross-notification service routing module configured to enabled a user to choose, and/or reply and/or initiate said notification in said different notification service which was used to initiate said notification; (d) said receiving unit module further configured to wake up said communication device to a fully active state and to presented said digital content even said communication device is in battery saving or resource preserving state; wherein said battery saving or resource preserving state selected from a group consisting of: sleep mode, idle mode, screen turned off, locked or any other conventional state of battery saving or resource preserving; (e) said upload unit adapted for providing publisher with a platform configured to enabled said publisher to upload, and/or share, and/or sell said digital content; (f) said receiving unit further configured to provide users with the ability to personalize their notifications using a digital content created by said publisher.

105. The computerized system of claim 87, wherein at least one of the following is being held true (a) said computerized system further comprising a module adapted for providing partner the ability to use said notification personalization service and to provide it to his customers, with his own definitions and flavor; wherein said partner's definitions and flavor selected from a group consisting of exclusive, brand and co-branded; (b) said upload unit further configured to enabled a user to uploaded content through his communication device or through said central digital content market; (c) said sending unit and wherein said receiving unit further configured to send a request said server to get the latest digital content catalog; wherein said server further configured to send a request to said database to get the latest digital content catalog; wherein said database further configured to returned said latest digital catalog to said server; further wherein said server further configured to returned said latest digital catalog to said digital content market or said communication device; (d) said sending unit further configured to enabled a user to selects content through his communication device or through said central digital content market, and to request from said server permissions to use them; wherein said request is done after said digital content market or said communication device instructs a user to perform various tasks that will grant him these permissions; further wherein said various tasks are selected from a group consisting of payment, share with friends, providing rating, providing feedback, twitter, posting, distribute the app and/or publish the app, register to a subscription and/or plan and/or coupons, and any combination thereof; and any combination thereof.

106. The computerized system of claim 87, wherein at least one of the following is being held true (a) said computerized system further configured to enabled a user to create or use his own digital content for his notification personalization; (b) said uploading unit further configured to enabled said digital content market or said communication device to send said digital content itself and its meta-data to said server for saving it for future use; wherein said server further configured to process said digital content and to saves said digital content meta-data on said database and said digital content on said digital content storage; (c) said sending unit further configured to send said notification to all listeners including said notification listener in said communication device and to a system listener in said server; (d) said sending unit further configured to determine to which communication devices to pass on said notification according to a notification personalization definitions; (e) said sending unit further configured to enable a user to sends said notification with personalized notification to a non-system user, thereby controlling said notification personalization in the receiver side; (f) said receiving unit module further configured to enable said non-system user to experience said notification personalization via performing an action on said received notification; further wherein said action selected from a group consisting of: clicking on a link in the notification to view said digital content on a web site, or clicking on a link to download said needed application and become a system user; (g) said receiving unit adapted for retrieving said digital content from said digital content storage [310] or from said external digital content source; and any combination thereof.
